(19) United States
(12) Patent Application Publication
(10) Pub. No.: US 2013/0346228 A1
(43) Pub. Date: Dec. 26, 2013

(54) SYSTEM AND METHOD FOR MANAGING NEWS MATERIALS OBTAINED BY BYSTANDERS

(71) Applicant: Satoshi Ono, Irvine, CA (US)

(72) Inventor: Satoshi Ono, Irvine, CA (US)

(21) Appl. No.: 13/770,837

(22) Filed: Feb. 19, 2013

Related U.S. Application Data
(60) Provisional application No. 61/662,430, filed on Jun. 21, 2012.
(60) Provisional application No. 61/733,506, filed on Dec. 5, 2012.

(51) Int. Cl. G06Q 50/18; G06Q 10/00

(52) U.S. Cl. CPC G06Q 50/184; G06Q 10/00
USPC 705/26.3; 705/310

(57) ABSTRACT

A system and method are configured to provide business entities with news materials obtained by bystanders. The method includes receiving a news material from a device of a bystander, the news material related to an event that the bystander encountered, sending the news material to one or more business entities who want to obtain the news material, and managing associated transactions. The transfer of the news material can be made either exclusively to a winning bidder through an action or non-exclusively to multiple business entities through licensing.

### CROSS REFERENCE

This application claims the benefit of U.S. provisional application Ser. No. 61/662,430, filed on Jun. 21, 2012, and Ser. No. 61/733,506, filed on Dec. 5, 2012.

### BACKGROUND

New generations of cellular phones, smartphones, laptops, tablets and other wireless communication devices can be embedded with increased number of applications. An application herein refers to a computer program designed to help users perform an activity. Such applications are designed for video viewing, digital media downloading and uploading, games, navigations and various other entertainment as well as utility activities. For example, a user carrying a smartphone can take a video of an event he/she happens to encounter, and the video can be uploaded almost immediately to a site on the Internet, such as YouTube® and Facebook®, allowing the public to watch the video as soon as uploaded and yet free of charge. Meanwhile, in the TV broadcasting world, reality TV shows and variety shows including games, cooking contests, singing contests and various other entertaining events are becoming popular. In contrast to such productions geared toward entertainment, news reporting remains as a valuable task in informing people of important events happening anywhere in the world as fast as possible. Conventionally, news media such as a TV broadcasting company dispatches a reporter and a supporting crew to an event site to obtain a news material. However, this is a costly operation, and transmission of the news material often experiences a time delay in reaching the public. TV news viewing is thus losing favor against video viewing on the Internet.

Accordingly, the present invention is directed to a new type of system and method that enable fast transmission and proper valuation of news materials for TVs, radios, newspapers, magazines and various other news media.

### BRIEF DESCRIPTION OF THE DRAWINGS

FIG. 1 illustrates conventional schemes in which data such as in form of images and/or sounds of a news material flows from an event site to viewers.

FIG. 2 illustrates an example of a system for controlling the flow of a news material and associated information.

FIG. 3 illustrates the details of the system of FIG. 2.

FIG. 4 is a flowchart illustrating the operations that may be carried out by the server for auctioning a news material.

FIG. 5 is a flowchart illustrating the operations that may be performed by using the first application for the auction process of a news material.

FIG. 6 is a flowchart illustrating the operations that may be performed by using the second application for the auction process of a news material.

FIG. 7 is a flowchart illustrating the operations that may be carried out by the server for licensing of a news material.

FIG. 8 is a flowchart illustrating the operations that may be performed by using the first application for licensing of a news material.

FIG. 9 is a flowchart illustrating the operations that may be performed by using the second application for licensing of a news material.

FIG. 10 is a flowchart illustrating the operations that may be carried out by the server for purchasing a news material as an intermediary buyer, followed by selling or licensing the news material.

FIG. 11 is a flowchart illustrating the operations that may be carried out by the server for exclusively selling a news material to a target buyer.

### DETAILED DESCRIPTION

A system and method to achieve fast transmission and proper valuation of news materials are described below with reference to accompanying drawings.

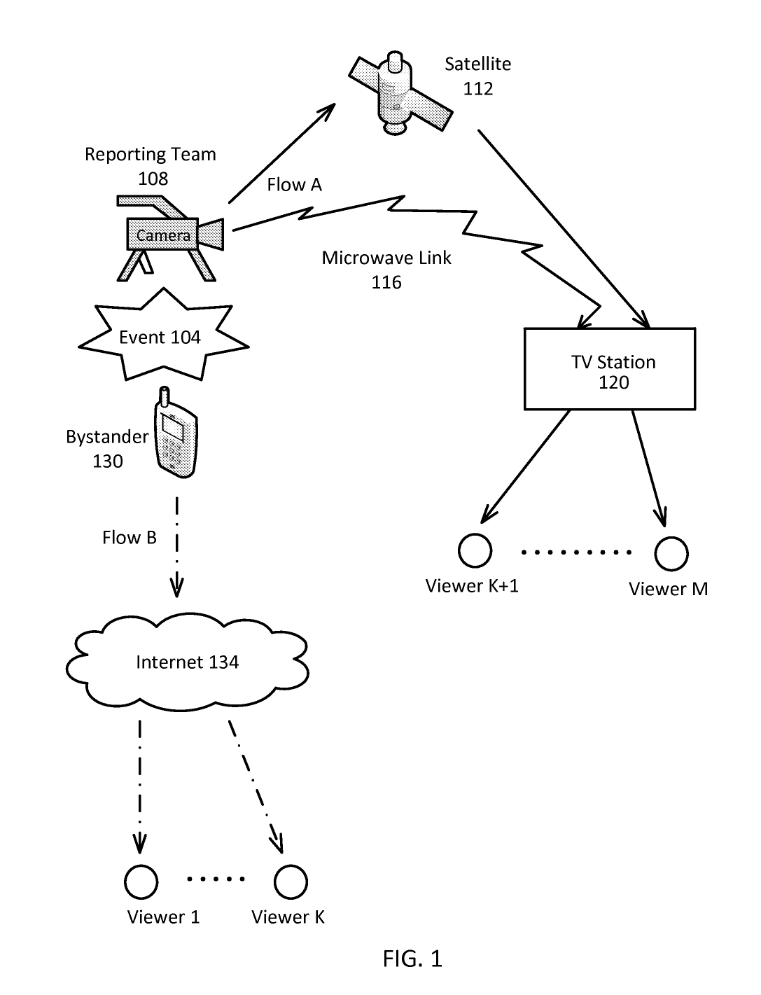

FIG. 1 illustrates conventional schemes in which data such as in form of images and/or sounds of a news material flows from an event site to viewers. In this figure, the information flow based on a conventional TV broadcasting system is depicted as Flow A with solid lines, and the information flow based on the Internet and a portable device is depicted as Flow B with dashed-dotted lines. Events to be captured in form of images and/or sounds and thereafter transmitted to viewers include natural disasters such as an earthquake, tsunami, tornado, hurricane, snow storm and the like, a demonstration by activists, a terrorist attack, a political insurgency in an oppressed country, a traffic accident, a crime, a celebrity passing by, a royal wedding and various other happenings and incidental occurrences with news values that people generally wish to view. An event 104 in FIG. 1 indicates one such example. According to the conventional TV broadcasting, a reporting team 108, generally including a reporter, a camera crew and other technical staff, is dispatched from a TV station to the event site to capture images and sounds using one or more TV cameras and one or more microphones. The signals including the captured images and sounds are transmitted through a satellite 112 for long-distance transmission or a microwave link 116 for relatively short-distance transmission. The signals are received by a receiving apparatus, such as a satellite dish or an antenna, associated with the TV station 120. The transmission between the reporting team 108 and the TV station 120 is generally handled by a contribution circuit, i.e., point-to-point circuit, and its peripherals. The received information is edited at the TV station 120 and then sent to distribution circuits, such as cable TV headends, direct-to-home satellite platforms, or terrestrial broadcasting networks, to reach viewers. A TV set is generally used by the viewer to watch the broadcast event or news.

In addition to the conventional TV broadcasting process, as illustrated with reference to Flow A of FIG. 1, an emerging, popular broadcasting process is illustrated with reference to Flow B, which is based on the Internet and a portable device, such as a smartphone, cellular phone, tablet, digital camera and the like. When the event 104 occurs, a bystander 130 is likely to be present to witness the event 104 earlier than the time when the reporting team 108 arrives at the event site, since the reporting team is often dispatched after the fact. The event 104 that has news values tends to occur unexpectedly. The bystander 130 may use his/her smartphone to capture the images and sounds of the event 104, which are then uploaded to a site on the Internet, such as YouTube®, Facebook® and the like, allowing a large number of viewers to watch the event 104 promptly and free of charge. In fact, such news materials obtained by bystanders can often be a valuable scoop that the TV stations may want to purchase for their own broadcasting. In other words, in the news reporting arena, the professional news media such TV broadcasting companies are losing their completive edge against amateurs who have a smartphone or other portable device with access to the Internet.

However, a problem associated with the broadcasting process based on the Internet and a portable device is that the value of a news material tends to get lost in the Internet-based mass media enabling instant communication to reach a large audience. The news material can otherwise be obtained by professional reporters and the associated crew exclusively, and may be valued as important information to be transmitted to the general public and stored as a valuable historical record. On the other hand, the news materials uploaded to social network sites on the Internet may be dispersed uncontrollably and eventually forgotten. In view of the above problem, the system and method according to the present invention are devised to reestablish the value of news materials and return the broadcasting task under the professionals' control. Additionally, the present system and method are provided to eliminate the significant cost that is conventionally expended for establishing and maintaining the contribution circuit (e.g., the point-to-point circuit between the reporting team 108 and the TV station 120) and its peripherals mentioned earlier with reference to FIG. 1.

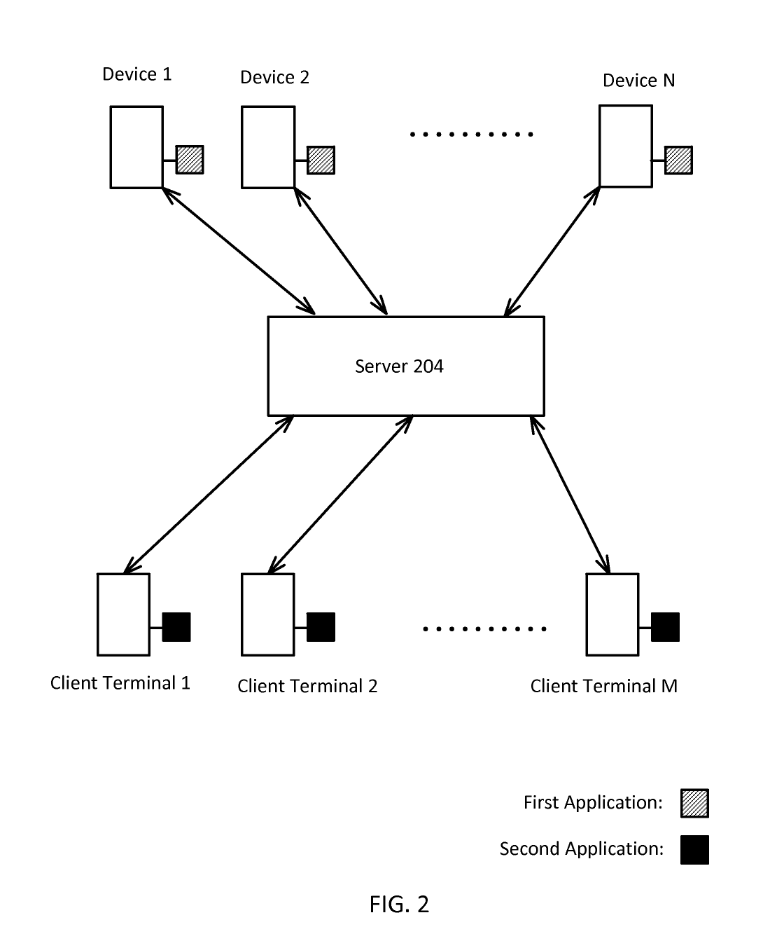

FIG. 2 illustrates an example of a system for controlling the flow of a news material and associated information. This system is configured based on the notion of C-to-B (consumer to business). The consumers in this case refer to bystanders who happen to be present at the event site to witness the event, and the business entities refer to news providers such as: CNN, Fox News, NHK, BBC, Reuters, etc. whose services include TV broadcasting of news; Time, Business Week, US News and World Report and other companies who publish magazines and periodicals; radio stations; nation-wide as well as local newspaper companies; tabloid publishing companies and so on. TV broadcasting is addressed earlier with reference to FIG. 1 as an example showing the conventional information flow from the event site to the viewers, wherein both images and sounds are utilized to reproduce the scene of the event 104 on the TV set used by the viewer. For newspapers, magazines, tabloids and other media that rely on visuals, only the images representing the event captured by one or more cameras, for example, are needed. The images can be in form of a stream as a video or still images as photographs. Alternatively, for radio broadcasting, only the sounds representing the event captured by one or more microphones, for example, are needed. The bystander may carry a smartphone, a cellular phone, a tablet, a digital camera, a recorder or other portable device that is equipped with one or more cameras and/or one or more microphones to capture the images and/or sounds of the event. In FIG. 2, devices 1, 2 . . . and N refer to devices used by bystanders 1, 2 . . . and N, respectively. The device can be a standalone smartphone, a cellular phone or other mobile device that is capable of running applications in addition to capturing images and sounds. Alternatively, the device can be a combination of a digital camera and a personal computer, a combination of a recorder and a personal computer, or any other combination with a computer, wherein the visual or voice data can be transferred to the computer that is capable of running applications. In FIG. 2, client terminals 1, 2 . . . and M refer to computers or servers used by the business entities 1, 2 . . . and M, respectively, such as TV stations, magazine companies, radio stations, newspaper companies, tabloid companies and other news providers.

Each of the devices 1, 2 . . . and N is coupled with a first application, indicated by a hatched box in FIG. 2. The first application is programed for performing operations to handle the tasks on the bystander side. The first application can be downloaded from a site through the Internet and placed in the device, such as in a smartphone or in a personal computer that receives data from a digital camera or a recorder. Alternatively, the first application can be distributed directly from the distributer of the first application, or placed externally to the device, for example, in the cloud computing environment. Each of the client terminals 1, 2 . . . and M is coupled with a second application, indicated by a solid box in FIG. 2. The second application is programed to perform operations to handle the tasks on the business entity side. The second application can be downloaded from a site through the Internet and placed in the client terminal, distributed directly from the distributer of the second application, or placed externally to the client terminal, for example, in the cloud environment. A server 204 is coupled to the devices 1, 2 . . . and N and the client terminals 1, 2 . . . and M. The communication links between the server 204 and the devices as well as between the server 204 and the client terminals may be based on any one of or a combination of the Internet, a private network, a satellite communication, a wireless communication and other communication or network schemes.

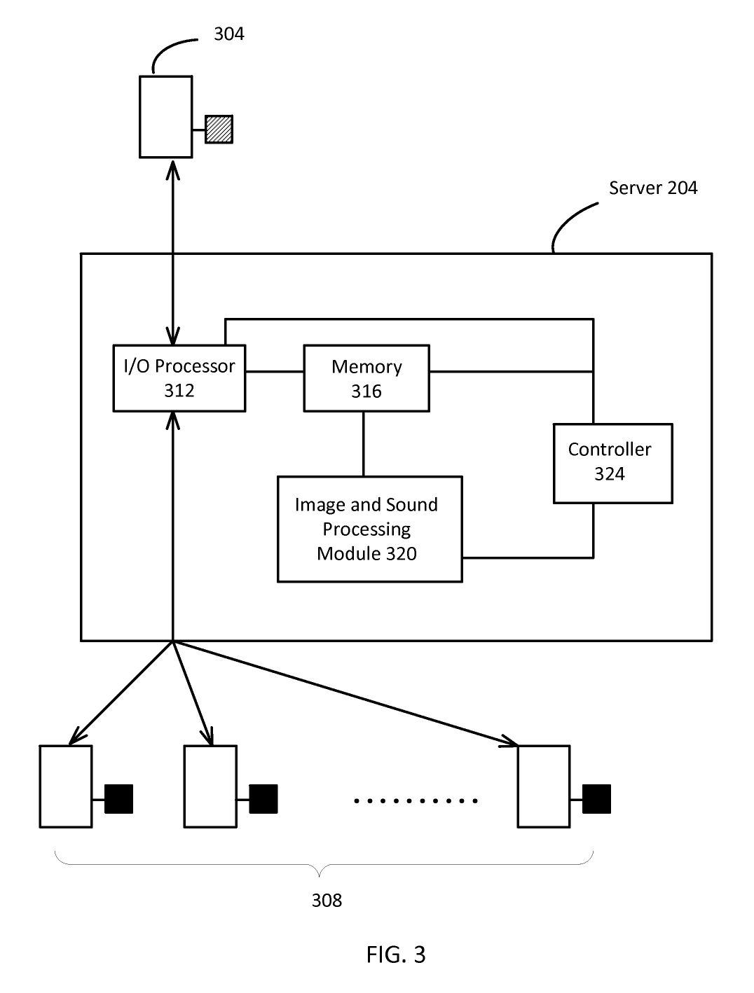

FIG. 3 illustrates the details of the system of FIG. 2. The flow of data and associated information is indicated by arrows for the case where one bystander communicates with the server 204 using the device 304 coupled with the first application, and multiple business entities communicate with the server 204 using the respective client terminals 308, each coupled with the second application. This system is configured for the bystander to submit a news material, and for the business entities to participate in the process to obtain the news material. The first application, the second application and the server 204 are configured to work cooperatively for receiving the news material including images and/or sounds of an event captured by the bystander, processing the news material, managing transactions, providing the news material to a business entity who wishes to obtain the material, and various other operations. The example in FIG. 3 is illustrated, for simplicity, for the case of one bystander communicating with the server. However, multiple bystanders can communicate simultaneously with the server 204 for submitting different materials representing the same event or different events. Similarly, multiple bystanders can communicate with the server 204 at arbitrary times for submitting different materials representing the same event or different events.

The first application may be run when the bystander wishes to submit his/her news material. A prompt page may be configured to show up on the screen of the device 304 so that the bystander can easily input necessary information. The prompt page may include an inquiry as to whether the bystander is ready to submit the news material including the captured images and/or sounds. If yes, the first application may be used to control the device 304 to send the material to the server 204. The input information may include the account information pertaining to the bystander, such as an ID or the name of the bystander, his/her choice of the transaction method (credit card, PayPal®, money order, Bitcoin, etc.), his/her credit card number if the credit card transaction is chosen, and so on. Additionally, the prompt page may include an inquiry regarding legal matters, for example, whether the bystander agrees to give up and transfer the ownership of the news material to a business entity who will eventually purchase the material, or whether the bystander agrees with non-exclusive licensing of the material to multiple business entities. An explanation about copyright law may be included in the prompt page. For example, the owner of the news material may need to be informed about some rules that the transfer of exclusive rights must be made in writing and signed by the owner of the rights conveyed in most countries. Optionally, the input information may include personal preferences of the bystander, such as selection of preferred business entities so as to exclude the others from the process. The input information about the bystander can be submitted at the same time as the news material, or prior to the submission, for example, when the bystander signs up to use the present process for submitting the news material.

As illustrated in FIG. 3, the server 204 may include an input/output (I/O) processor 312, a memory 316, an image and sound processing module 320, and a controller 324. The I/O processor 312 handles input/output tasks. For example, the news material including the captured images and/or sounds sent from the device 304 of the bystander is received at the I/O processor 312. The material may then be stored in the memory 316 as a binary file, for example. The input information, such as the account information, legal matters and other information pertaining to the bystander, is also received at the I/O processor 312 and may be stored in the memory 316. The image and sound processing module 320 is configured to process the received images and/or sounds and prepare them for transmission to the client terminals 308. For example, the image and sound processing module 320 may be configured to simplify, hatch, or shorten the stream of the images and/or sounds to create a preview version for the business entities to review before initiating the acquisition process. Alternatively, the image and sound processing module 320 may be configured to watermark the images to create the preview version so as to prevent generation of illegal copies. The original version may undergo a minor edit at the image and sound processing module 316, such as changing the file format for better transmission and reception, for example. The preview version and the original version with or without edits may be stored in the memory 316 before transmission to the client terminals 308. The server 204 further includes the controller 324, which may include a CPU and algorithms, for controlling components and modules in the server 204 to perform various operations. Instead of storing the news material in the memory 316 and/or processing the received images and sounds by the image and sound processing module 320, the controller 324 may be configured to control the I/O processor 312 to directly transmit the images and sounds to one or more of the client terminals 308. Such live transmissions may be arranged based on the needs from the business entities.

The I/O processor 312 may be configured to send a notice to the client terminals 308 upon receiving the news material and input information from the bystander, the notice indicating that a news material has been submitted and inviting the business entities to obtain the material. The second application coupled to each of the client terminals 308 can be run to receive the notice at the client terminal and initiate the process. Upon reading the notice, if any of the business entities are interested, they can request for the preview version from the server 204. Alternatively, the notice and the preview version can be sent together to the client terminals 308. The second application can be configured to replay the preview version on the client terminal. If any of the business entities are interested in purchasing the news material based on the preview version, they can proceed to obtain the original version. The second application may be configured to submit a reply from the business entity to the server 204 and information pertaining to the business entity, e.g., an ID or the name of the business entity, the choice of the transact method (credit card, PayPal®, money order, Bitcoin, etc.), the credit card number if the credit card transaction is chosen, and so on. Alternatively, such information pertaining to the business entities may be obtained in advance based on a contract agreement, for example, and stored in the memory 316 of the server 204. Alternatively, the information can be sent with the request for the preview version, for example.

The replies from the business entity are received by the I/O processor 312. In case the news material is to be sold by auction, the controller 324 may be configured to collect the bidding prices from multiple bidders within a predetermined time period and determine a winning bidder who offered the highest price. An algorithm may be designed and implemented in the controller 324 to handle the bidding process. The predetermined time period should be relatively short, e.g., 30 minutes, since the speed is an important factor determining the news value. Thereafter, the controller 324 retrieves the original version of the news material including the captured images and/or sounds from the memory 316 and sends it through the I/O processor 312 to the client terminal of the winning bidder. The second application may be configured to control receiving of the captured images and/or sounds as well as the payment of the bidding price. Additionally, the first application may be configured to control receiving of the payment for the news material. The controller 324 of the server 204 may manage transactions in such a way that the payment corresponding to the bidding price is received from the winning bidder, and the payment to the bystander who submitted the news material is made after taking away a commission fee, e.g., 10%. The controller 324 may be configured to manage these transactions using the account information obtained from the bystander and the business entities, which may be stored in the memory 316. The winning bidder, such as a TV station, can broadcast the news material exclusively or resell the material to its affiliated companies, if the transfer of the news material is exclusive as in a transfer of entire ownership to the winning bidder. The images and/or sounds received and owned by the winning bidder may be processed to improve the quality, shortened for a news flash, embedded with a “Viewer Discretion Is Advised” warning, or edited as appropriate. The news material captured by the bystander is thus properly valued and broadcast promptly as a scoop by the winning bidder.

The news material may be non-exclusively licensed instead of being sold exclusively to the winning bidder through an auction. An algorithm may be designed and implemented in the controller 324 to handle the licensing process. The bystander may submit the news material to license part of the rights, for example, use right, to multiple business entities. The bystander may also submit an asking price, i.e., an asking amount of the license fee, of the news material. If there are business entities that agree to obtain the license to use the material at the asking price, the controller 324 is configured to retrieve the original version of the news material including the captured images and/or sounds from the memory 316 and sends it through the I/O processor 312 to the client terminals 304 respectively associated with the business entities, i.e., licensees. The second application may be configured to control receiving of the captured images and/or sounds as well as the payment of the license fee corresponding to the asking price. Additionally, the first application may be configured to control receiving of the payment for the news material. The controller 324 of the server 204 may manage transactions in such a way that the payment of the license fee is received from the licensees, and the payment to the bystander who submitted the news material is made after taking away a commission fee, e.g., 10%. The controller 324 may be configured to manage these transactions using the account information obtained from the bystander and the business entities, which may be stored in the memory 316.

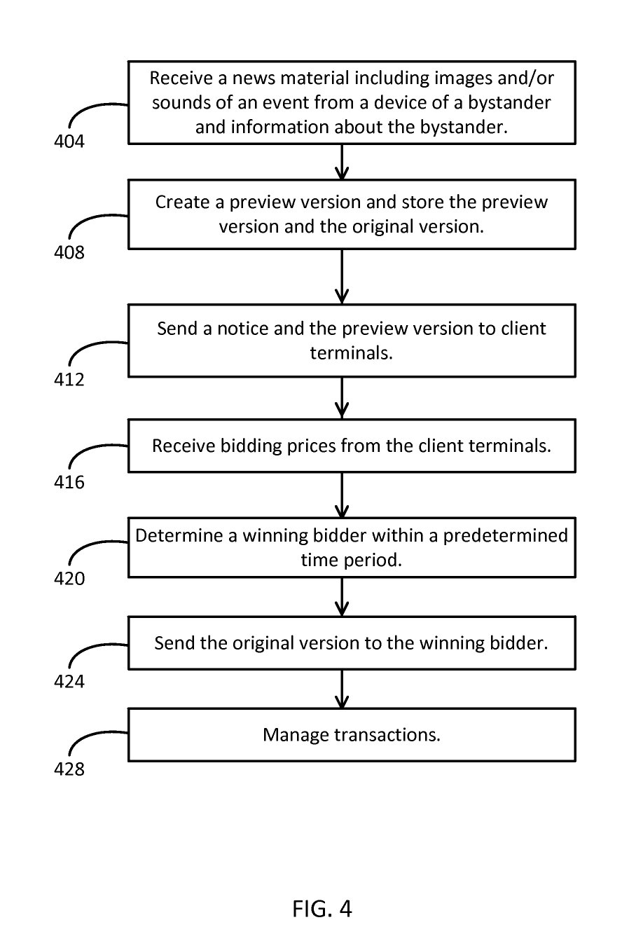

FIG. 4 is a flowchart illustrating the operations that may be carried out by the server 204 for auctioning a news material. An algorithm may be designed and implemented in the controller 324 of the server 204 to handle the auction process. The order of steps in this and other flowcharts illustrated in this document may not have to be the order that is shown. Some steps can be interchanged or sequenced differently depending on efficiency of operations, convenience for users or any other scenarios. Additionally, actions in one step may be performed at the same time or at different times, or actions in different steps may be performed at different times or at the same time. In some cases, one or more steps may be skipped for simplification. In step 404, a news material including images and/or sounds of an event sent from a device of a bystander is received. Input information about the bystander may also be received in this step. The input information may include the account information pertaining to the bystander, such as an ID or the name of the bystander, his/her choice of the transaction method (credit card, PayPal®, money order, Bitcoin, etc.), his/her credit card number if the credit card transaction is chosen, and so on. Additionally, the input information may include legal matters, for example, whether the bystander agrees to give up and transfer the ownership of the news material to a winning bidder who will eventually purchase the material. Optionally, the input information may include personal preferences of the bystander, such as selection of preferred business entities so as to exclude the others from the auction process. The input information about the bystander can be submitted at the same time as the news material, or prior to the submission, for example, when the bystander signs up to use the auction process of news materials. In step 408, a preview version of the received images and/or sounds is created by using the image and sound processing module 320 of the server 204. Such a preview version may be created by simplifying, hatching, or shortening the stream of the original images and/or sounds. Alternatively, the preview version may be created by watermarking the images so as to prevent generation of illegal copies. The original version may undergo a minor edit by the image and sound processing module 320, such as changing the file format for better transmission and reception, for example. The preview version and the original version with or without edits may be stored in the memory 316 of the server 204. In step 412, a notice is sent by the I/O processor 312 of the server 204 to the client terminals 308, the notice indicating that a news material has been submitted and inviting the business entities for bidding. Upon reading the notice, if any of the business entities are interested, they can request for the preview version from the server 204. Alternatively, the notice and the preview version can be sent together to the client terminals 308. If any of the business entities are interested in purchasing the news material after reviewing the preview version, they can bid a price for the material. In step 416, bidding prices are received from the client terminals 308 associated with the interested business entities. The information pertaining to the bidder, i.e., the business entity, may also be received in this step, such as an ID or the name of the business entity, the choice of the transaction method (credit card, PayPal®, money order, Bitcoin, etc.), the credit card number if the credit card transaction is chosen, and so on. Alternatively, such information pertaining to the business entities may be obtained in advance based on a contract agreement, for example, and stored in the memory 316 of the server 204. In step 420, a winning bidder is determined by using, for example, the algorithm implemented in the controller 324 of the server 204. The algorithm may be configured to collect bidding prices from multiple bidders and determine the winning bidder within a predetermined time period. The predetermined time period should be relatively short, e.g., 30 minutes, since the speed is an important factor determining the news value. In step 424, the original version of the news material is sent to the client terminal of the winning bidder. In step 428, transactions are managed by the controller 324 of the server 204. For example, the payment corresponding to the bidding price may be received from the winning bidder, and the payment to the bystander who submitted the news material may be made after taking away a commission fee, e.g., 10%. These transactions can be made using the account information obtained from the bystander and the business entities, which may be stored in the memory 316 of the server 204.

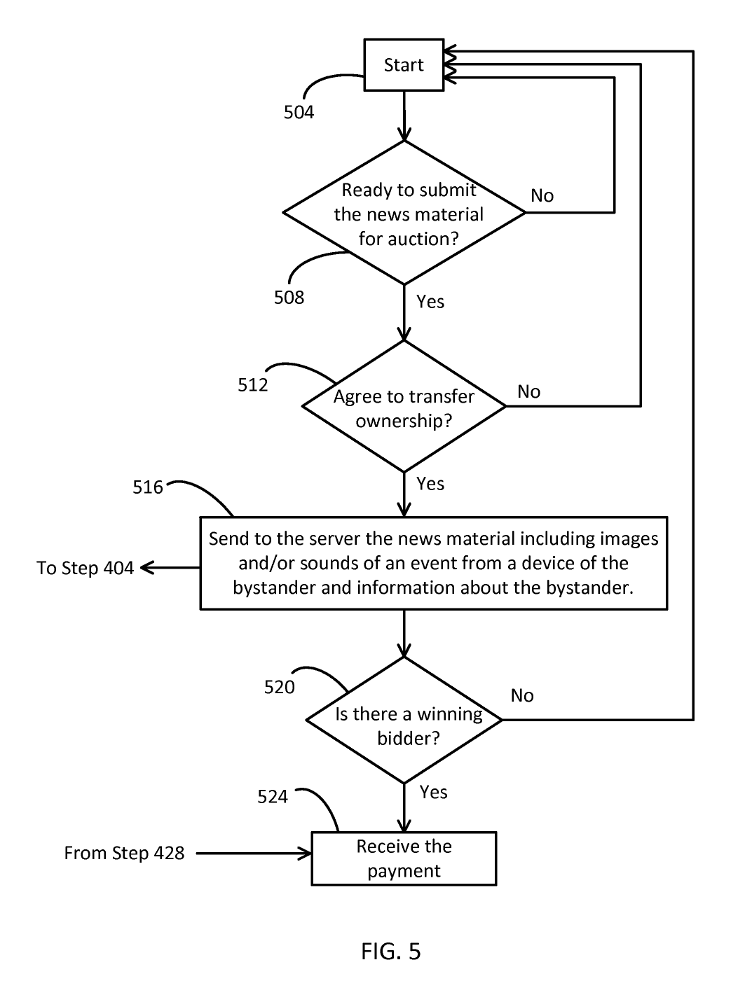

FIG. 5 is a flowchart illustrating the operations that may be performed by using the first application for the auction process of a news material. The first application is coupled to a device 304 of the bystander. Examples of the device 304 include a smartphone, a cellular phone, a tablet, a combination of a digital camera and a personal computer, and a combination of a recorder and a personal computer. One or more cameras and/or one or more microphones are included in the device 304 to capture images and/or sounds of an event such as an interesting happening and an incidental occurrence with a news value encountered by the bystander. The device 304 is capable of running applications, in addition to capturing images and/or sounds. In step 504, the first application is started when the bystander wishes to submit his/her news material for an auction. A prompt page may be configured to show up on the screen of the device 304 of the bystander so that the bystander can easily input necessary information. In step 508, an inquiry may be shown on the prompt page as to whether the bystander is ready to submit the news material including the captured images and/or sounds of an event. In step 512, an additional inquiry regarding, for example, legal matters, may be shown on the prompt page, as to whether the bystander agrees to give up and transfer the ownership of the news material to a winning bidder who will eventually purchase the material. An explanation about the copyright law may be included in the prompt page. For example, the owner of the news material may need to be informed about some rules that the transfer of exclusive rights must be made in writing and signed by the owner of the rights conveyed in most countries. If “yes” to both inquiries in steps 508 and 512, in step 516, the news material including the images and/or sounds of the event is sent from the device 304 to the server 204. At the server 204, in addition to storing the news material in the memory 316 and/or processing the received images and sounds by the image and sound processing module 320, real-time transmission of the images and/or sounds of the live event may also be configured. In step 516, input information about the bystander may also be sent to the server 204. The input information may include the account information pertaining to the bystander, such as an ID or the name of the bystander, his/her choice of the transaction method (credit card, PayPal®, money order, Bitcoin, etc.), his/her credit card number if the credit card transaction is chosen, and so on. Optionally, the input information may include personal preferences of the bystander, such as selection of preferred business entities so as to exclude the others from the auction process. The input information about the bystander can be submitted at the same time as the news material, or prior to the submission, for example, when the bystander signs up to use the auction process of news materials. The step 516 that may be performed by using the first application is coupled to the step 404 that may be carried out by the server 204, where the news material and the information about the bystander sent from the device 304 are received by the server 204. If it is determined that there is a winning bidder in step 520, receiving of the payment corresponding to the bidding price is controlled in step 524 using the account information. The step 524 that may be performed by using the first application is coupled to the step 428 that can be carried out by the server 204, where the transactions are managed.

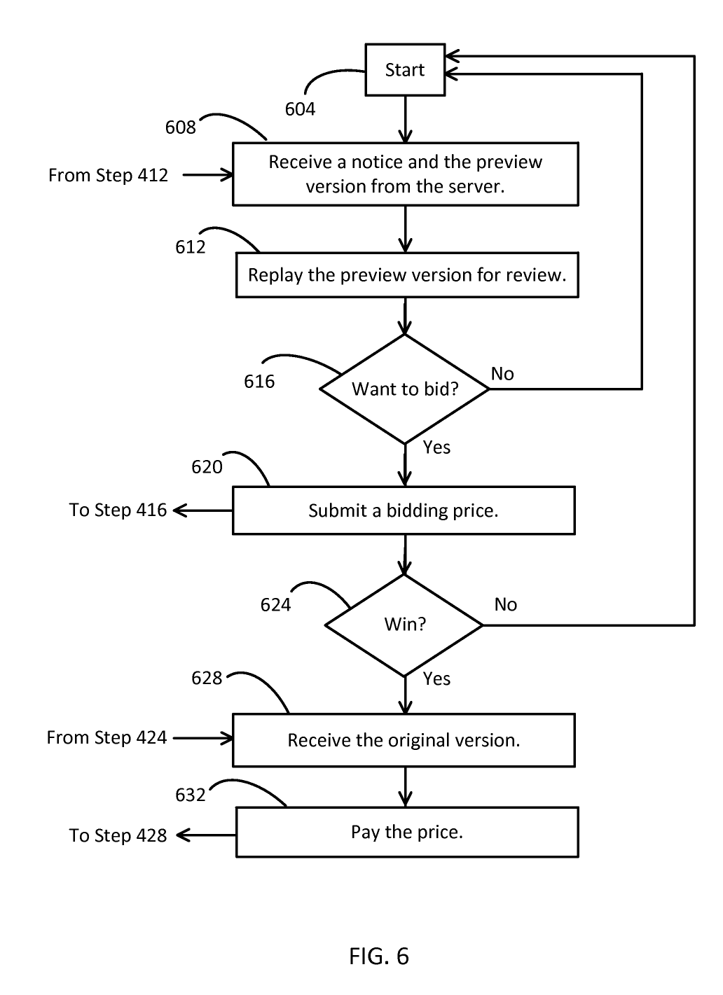

FIG. 6 is a flowchart illustrating the operations that may be performed by using the second application for the auction process of a news material. The second application is coupled to each of the client terminals 308 of respective business entities, and is programmed for performing operations to handle the tasks on the business entity side. In step 604, the second application is started when the business entity is interested in obtaining a news material via the auction process configured based on the present system. In step 608, a notice is received from the server 204, indicating that a news material has been submitted and inviting the business entities for bidding. Upon reading the notice, if any of the business entities are interested, they can request for the preview version from the server 204. Alternatively, the notice and the preview version can be sent together to the client terminals 308. The step 608 that may be performed by using the second application is coupled to the step 412 that may be carried out by the server 204, where the notice and the preview version are sent from the server 204 to the client terminals 308. In step 612, the preview version may be replayed on the client terminal. An inquiry may be made in step 616 as to whether the business entity wants to bid a price for the news material after reviewing the preview version. If yes, in step 620, the bidding price is submitted from the client terminal of the business entity to the server 204. Additionally, information pertaining to the business entity may be submitted, such as an ID or the name of the business entity, the choice of the transact method (credit card, PayPal®, money order, Bitcoin, etc.), the credit card number if the credit card transaction is chosen, and so on. Alternatively, such information pertaining to the business entities may be submitted in advance based on a contract agreement, for example, and stored in the memory 316 of the server 204. The step 620 that may be performed by using the second application is coupled to the step 416 that may be carried out by the servers 204, where bidding prices are received from the client terminals 308 of multiple business entities. If it is determined in step 624 that the business entity is a winning bidder offering the highest bidding price, the original version of the news material including the captured images and/or sounds is received at the client terminal of the winning bidder in step 628. The step 628 that may be performed by using the second application is coupled to the step 424 that may be carried out by the server 204, where the original version is sent from the server 204 to the client terminal of the winning bidder. In step 632, the payment of the bidding price is made using the account information. The step 632 that may be performed by using the second application is coupled to the step 428 that may be carried out by the server 204, where the transactions are managed.

The auction process described with reference to FIGS. 4-6 involves the transfer of entire ownership of the news material exclusively to the winning bidder. According to the U.S. Copyright Act, the transfer of exclusive rights must be made in writing and signed by the owner of the rights conveyed. Therefore, the transfer of the news material from the bystander who captured and decided to sell the material exclusively to the winning bidder must be made formally in writing. Although such a formal procedure needs to be taken between the bystander, i.e., the original owner of the news material, and the winning bidder, i.e., the business entity who wishes to monopolize the material, the sale price can be very high due to the exclusivity and the auction process in which multiple bidders may participate. Therefore, this auction process may be advantageous for a bystander who wants to monetize with a high price the captured images and/or sounds of an event that can be highly sensational and sought after.

Instead of transferring exclusive rights, the transfer may be made on a non-exclusive basis to multiple business entities. For example, only the use right, not the entire ownership of the news material, can be transferred to multiple business entities who are interested in broadcasting the news material. Such non-exclusive licenses need not be made in writing according to the U.S. Copyright Act. They can be made orally or even implied by the behavior of the parties. Thus, the procedure associated with non-exclusive licenses is relatively simple and fast as compared to the exclusive transfer of entire ownership; however, the sale price of the news material may become low in the case of licensing due to the lack of exclusivity. However, the bystander who captured images and/or sounds of an event can sell the partial rights of the material to multiple business entities, thereby potentially making a good profit in spite of the low unit price. The present system and method may be configured to provide an option of choosing selling the entire ownership to one business entity or licensing part of the rights, e.g., use right, non-exclusively to multiple business entities. A guideline may be provided for users to be aware of the differences between the two cases, as well as advantages, disadvantages, warnings and so on pertaining to the two cases.

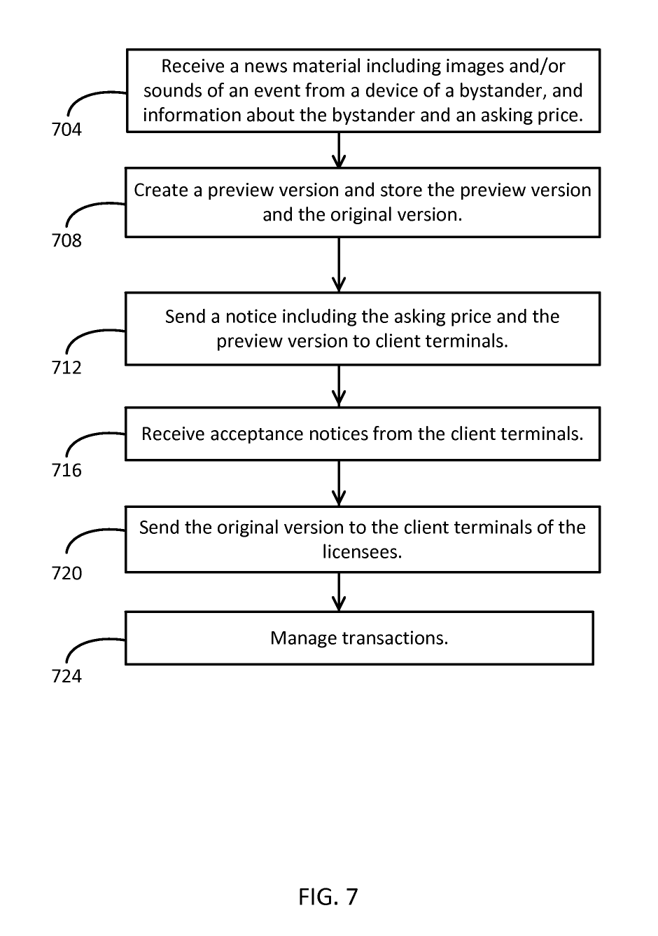

FIG. 7 is a flowchart illustrating the operations that may be carried out by the server 204 for licensing of a news material. An algorithm may be designed and implemented in the controller 324 of the server 204 to handle the license process. In step 704, a news material including images and/or sounds of an event sent from a device of a bystander is received. Input information about the bystander can also be received in this step. The input information may include the account information pertaining to the bystander, such as an ID or the name of the bystander, his/her choice of the transaction method (credit card, PayPal®, money order, Bitcoin, etc.), his/her credit card number if the credit card transaction is chosen, and so on. Additionally, the input information may include legal matters, for example, whether the bystander agrees to non-exclusively license part of the rights, for example, use right, associated with the news material to potential licensees. An asking price of the news material, i.e., an asking amount of a license fee, set by the bystander may also be received in this step. Optionally, the input information may include personal preferences of the bystander, such as selection of preferred business entities so as to exclude the others from the license process. The input information about the bystander can be submitted at the same time as the news material, or prior to the submission, for example, when the bystander signs up to use the license process of news materials. In step 708, a preview version of the received images and/or sounds is created by using the image and sound processing module 320 of the server 204. Such a preview version may be created by simplifying, hatching, or shortening the stream of the original images and/or sounds. Alternatively, the preview version may be created by watermarking the images so as to prevent generation of illegal copies. The original version may undergo a minor edit by the image and sound processing module 320, such as changing the file format for better transmission and reception, for example. The preview version and the original version with or without edits may be stored in the memory 316 of the server 204. In step 712, a notice is sent by the I/O processor 312 of the server 204 to the client terminals 308, the notice indicating that a news material has been submitted and inviting the business entities to obtain the license to use the material at the asking price, i.e., the asking amount of the license fee set by the bystander. Upon reading the notice, if any of the business entities are interested, they can request for the preview version from the server 204. Alternatively, the notice and the preview version can be sent together to the client terminals 308. If any of the business entities are interested in licensing-in the news material after reviewing the preview version, they can send an acceptance notice to the server 204, the acceptance notice indicating that the business entity agrees to obtain the license to use the news material at the asking price. In step 716, the acceptance notices are received from the client terminals 308 associated with the interested business entities. The information pertaining to the business entity may also be received in this step, such as an ID or the name of the business entity, the choice of the transaction method (credit card, PayPal®, money order, Bitcoin, etc.), the credit card number if the credit card transaction is chosen, and so on. Alternatively, such information pertaining to the business entities may be obtained in advance based on a contract agreement, for example, and stored in the memory 316 of the server 204. In step 720, the original version of the news material is sent to the client terminal associated with each of the business entities who sent the acceptance notice. These business entities are licensees of the news material. In step 724, transactions are managed by the controller 324 of the server 204. For example, the payment of the license fee may be received from the licensees, and the payment to the bystander who submitted the news material may be made after taking away a commission fee, e.g., 10%. These transactions can be made using the account information obtained from the bystander and the business entities, which may be stored in the memory 316 of the server 204.

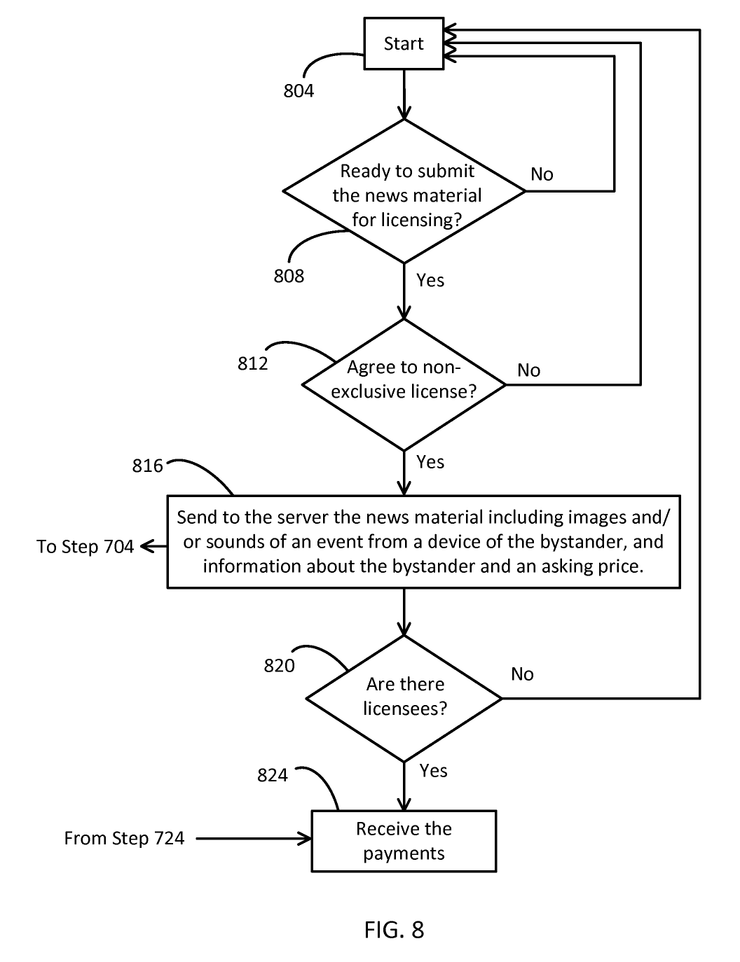

FIG. 8 is a flowchart illustrating the operations that may be performed by using the first application for licensing of a news material. The first application is coupled to a device 304 of the bystander. Examples of the device 304 include a smartphone, a cellular phone, a tablet, a combination of a digital camera and a personal computer, and a combination of a recorder and a personal computer. One or more cameras and/or one or more microphones are included in the device 304 to capture images and/or sounds of an event such as an interesting happening and an incidental occurrence with a news value encountered by the bystander. The device 304 is capable of running applications, in addition to capturing images and/or sounds. In step 804, the first application is started when the bystander wishes to submit his/her news material for licensing. A prompt page may be configured to show up on the screen of the device 304 of the bystander so that the bystander can easily input necessary information. In step 808, an inquiry may be shown on the prompt page as to whether the bystander is ready to submit the news material including the captured images and/or sounds of an event. In step 812, an additional inquiry regarding legal matters, for example, may be shown on the prompt page, as to whether the bystander agrees to non-exclusively license part of the rights, for example, use right, associated with the news material to potential licensees. If “yes” to both inquiries in steps 808 and 812, in step 816, the news material including the images and/or sounds of the event is sent from the device 304 to the server 204. At the server 204, in addition to storing the news material in the memory 316 and/or processing the received images and sounds by the image and sound processing module 320, real-time transmission of the images and/or sounds of the live event may also be configured. In step 816, input information about the bystander may also be sent to the server 204. The input information may include the account information pertaining to the bystander, such as an ID or the name of the bystander, his/her choice of the transaction method (credit card, PayPal®, money order, Bitcoin, etc.), his/her credit card number if the credit card transaction is chosen, and so on. An asking price of the news material, i.e., an asking amount of a licensing fee, set by the bystander may also be submitted in this step. Optionally, the input information may include personal preferences of the bystander, such as selection of preferred business entities so as to exclude the others from the license process. The input information about the bystander can be submitted at the same time as the news material, or prior to the submission, for example, when the bystander signs up to use the license process of news materials. The step 816 that may be performed by using the first application is coupled to the step 704 that may be carried out by the server 204, where the news material and the information about the bystander and the asking price sent from the device 304 are received by the server 204. It is determined in step 820 if there are business entities who agree to obtain the license to use the news material at the asking price. These business entities are licensees of the news material. Receiving of the payment of the license fee is controlled in step 824 using the account information. The step 824 that may be performed by using the first application is coupled to the step 724 that can be carried out by the server 204, where the transactions are managed.

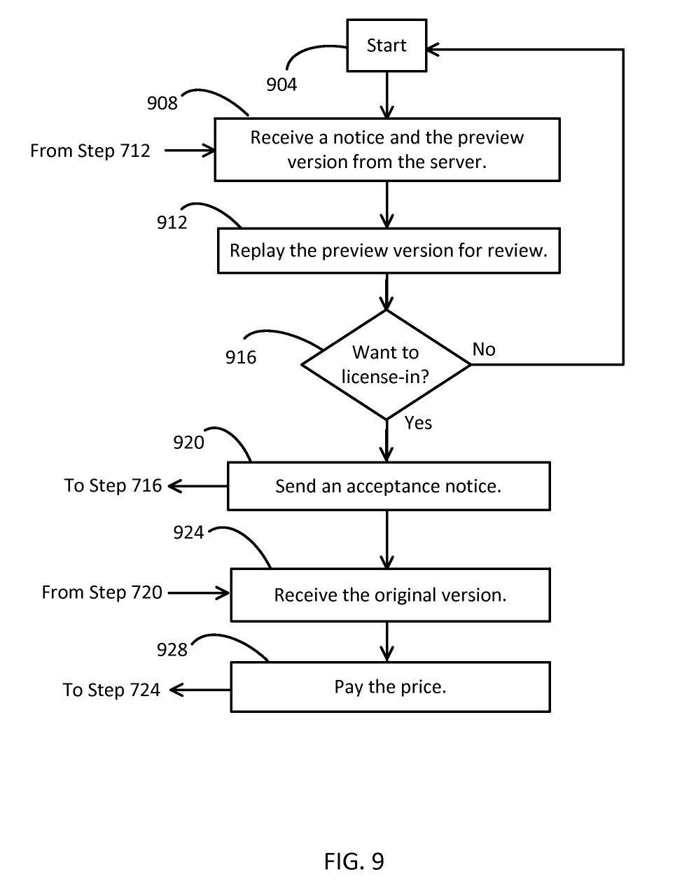

FIG. 9 is a flowchart illustrating the operations that may be performed by using the second application for licensing of a news material. The second application is coupled to each of the client terminals 308 of respective business entities, and is programmed for performing operations to handle the tasks on the business entity side. In step 904, the second application is started when the business entity is interested in obtaining a news material via the license process configured based on the present system. In step 908, a notice is received from the server 204, indicating that a news material has been submitted and inviting the business entities to obtain the license to use the material at the asking price, i.e., the asking amount of the license fee. Upon reading the notice, if any of the business entities are interested, they can request for the preview version from the server 204. Alternatively, the notice and the preview version can be received together at the client terminals 308. The step 908 that may be performed by using the second application is coupled to the step 712 that may be carried out by the server 204, where the notice and the preview version are sent from the server 204 to the client terminals 308. In step 912, the preview version may be replayed on the client terminal. In step 916, it is determined if the business entity associated with the client terminal is interested in licensing-in the news material after reviewing the preview version. If “yes,” the business entity can send an acceptance notice to the server 204 in step 920, the acceptance notice indicating that the business entity agrees to obtain the license to use the news material at the asking price. Additionally, information pertaining to the business entity may be submitted in this step, such as an ID or the name of the business entity, the choice of the transact method (credit card, PayPal®, money order, Bitcoin, etc.), the credit card number if the credit card transaction is chosen, and so on. Alternatively, such information pertaining to the business entities may be submitted in advance based on a contract agreement, for example, and stored in the memory 316 of the server 204. The step 920 that may be performed by using the second application is coupled to the step 716 that may be carried out by the servers 204, where the acceptance notices are received from the client terminals 308 associated with the interested business entities. In step 924, the original version of the news material is received at the client terminal associated with each of the business entities who sent the acceptance notice. The step 924 that may be performed by using the second application is coupled to the step 720 that may be carried out by the server 204, where the original version is sent. In step 928, the payment of the license fee is made using the account information. The step 928 that may be performed by using the second application is coupled to the step 724 that may be carried out by the server 204, where the transactions are managed.

The asking price, i.e., the asking amount of the license fee, in the above examples is set by the original owner of the news material, i.e., the bystander who captured the images and/or sounds of an event. In some cases, setting such a price may be difficult due to ambiguities and/or inexperience in evaluating market prices of news materials. The server 204 may be configured to offer suggestions or recommendations in such cases by taking into consideration experts' opinions, past pricing of similar materials, etc. However, in any case, the time it takes to reach the final price must be made short, since the speed for a news material to reach a general audience is an important factor determining the news value.

The processes described above with reference to FIGS. 4-9 utilize primarily the brokering functionality configured in the server 204 for transferring a news material from the bystander who captured the images and/or sounds of an event to one or more business entities. That is, various transactions between a seller and a buyer are arranged primarily by the server 204 representing the broker, who gets a commission when the deal is executed. Instead of using the server 204 as a broker, it is possible to use the server 204 as an intermediary buyer. That is, the server 204 can be configured to serve as an intermediary buyer, who first purchases the news material from the bystander, and thereafter sell or license the acquired news material to business entities. In contrast to the commission-based brokering, the intermediary buyer can make profits from the difference between the purchase price and the selling price (or total license fees) of the news material. The transfer of the news material from the bystander to the intermediary buyer is exclusive in this case; thus, once the entire ownership is transferred, the new owner, i.e., the intermediary buyer, has vast flexibility in handling the acquired news material to profit from it.

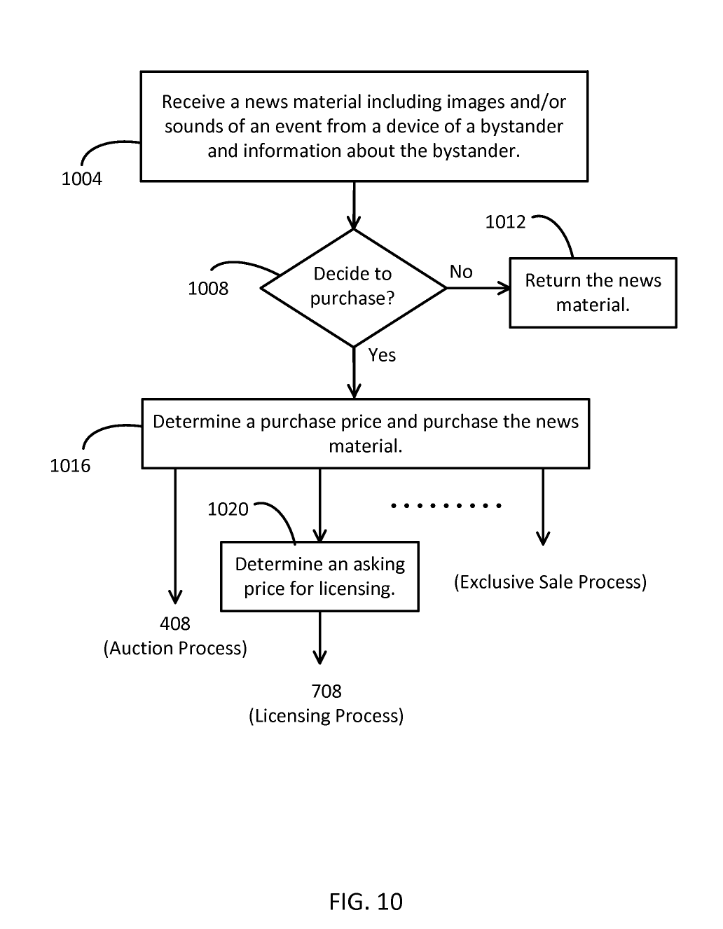

FIG. 10 is a flowchart illustrating the operations that may be carried out by the server 204 for purchasing a news material as an intermediary buyer, followed by selling or licensing the news material. In step 1004, a news material including images and/or sounds of an event sent from a device of a bystander is received. Input information about the bystander may also be received in this step. The input information may include the account information pertaining to the bystander, such as an ID or the name of the bystander, his/her choice of the transaction method (credit card, PayPal®, money order, Bitcoin, etc.), his/her credit card number if the credit card transaction is chosen, and so on. Additionally, the input information may include legal matters, for example, whether the bystander agrees to give up and transfer the ownership of the news material to the intermediary buyer represented by the server 204. The input information about the bystander can be submitted at the same time as the news material, or prior to the submission of the news material. In step 1008, it is determined if the submitted news material be purchased by the intermediary buyer. If “No,” the server 204 returns the news material to the bystander. Alternatively or additionally, the news material in electronic form may be deleted from the server and the confirmation that the news material has been deleted may be sent to the bystander. If “Yes,” the process goes to step 1016, where a purchase price is proposed by the server 204 representing the intermediary buyer, and the news material is purchased at the price. The purchase price may be decided based on experts' recommendations and suggestions, past pricing of similar materials, and the like. If the bystander does not agree with the proposed price, negotiations may be arranged so as to reach an agreed-upon price. If no agreement is made, the sale/purchase of the news material may be breached at this point. However, once the news material is acquired by the intermediary buyer, there are a wide variety of ways to sell, license or distribute the news material to business entities.

One way is to auction the news material. In this case, the process goes to step 408 from step 1016 and follows the auction process as illustrated in FIG. 4. The operations on the business entity side may be performed by using the second application as illustrated in FIG. 6.

Another way is to non-exclusively license the news material. In this case, in step 1020, the intermediary buyer, who is now a licensor, determines an asking price, i.e., an asking amount of the license fee, to license part of rights, e.g., use right, associated with the news material. Here, again, the asking price may be decided based on experts' recommendations and suggestions, past pricing of similar materials, and the like. Thereafter, the process goes to step 708 and follows the licensing process as illustrated in FIG. 7. The operations on the business entity side may be performed by using the second application as illustrated in FIG. 9.

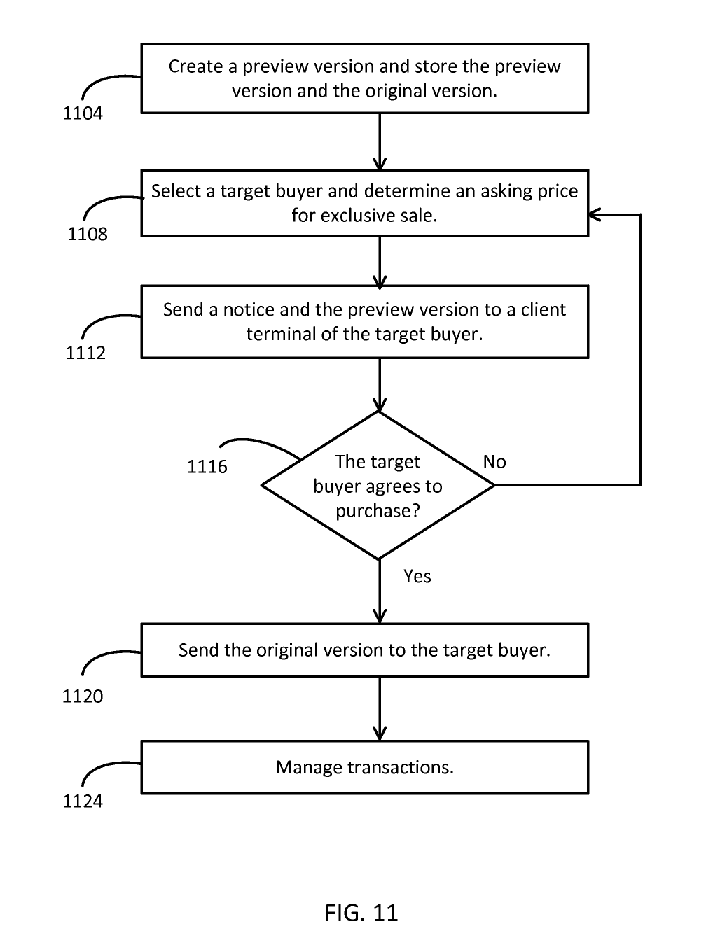

Yet another way is to exclusively sell the news material to a target buyer, who is selected from the multiple business entities. FIG. 1 is a flowchart illustrating the operations that may be carried out by the server 204 for exclusively selling the acquired news material to a target buyer. After the news material is acquired in step 1016 of FIG. 10, the process goes to step 1104 of FIG. 11, where a preview version of the images and/or sounds of the news material is created by using the image and sound processing module 320 of the server 204. Such a preview version may be created by simplifying, hatching, or shortening the stream of the original images and/or sounds. Alternatively, the preview version may be created by watermarking the images so as to prevent generation of illegal copies. The original version may undergo a minor edit by the image and sound processing module 320, such as changing the file format for better transmission and reception, for example. The preview version and the original version may be stored in the memory 316 of the server 204. In step 1108, the intermediary buyer represented by the server 204 selects a target buyer from the multiple business entities, and determines an asking price for selling the news material exclusively to the target buyer. In step 1112, a notice is sent by the I/O processor 312 of the server 204 to the client terminal of the target buyer, the notice indicating that a news material has been acquired and inviting the business entity who is the target buyer to purchase. Upon reading the notice, if the target buyer is interested, he/she can request for the preview version from the server 204. Alternatively, the notice and the preview version can be sent together to the client terminal of the target buyer. In step 1116, it is determined if the target buyer agrees to purchase the news material. If “No,” the process goes back to step 1108 to look for another target buyer, and optionally change the asking price of the news material. If “Yes,” the process goes to step 1120, where the original version of the news material is sent to the client terminal of the target buyer. In step 1124, transactions are managed by the controller 324 of the server 204 using the account information pertaining to the target buyer. For example, the payment corresponding to the asking price may be received from the target buyer in this step.

The present system and method allow business entities, such as TV stations, magazine companies, radio stations, newspaper companies, tabloid companies and other news reporting media, to obtain news materials fast. This is because the images and/or sounds of an event captured by bystanders at the event site are used and distributed quickly through the present processes. The purchase prices or the license fees that the business entities pay to obtain the news material are expected to be much lower than costs required for dispatching a reporting team to the event site, and the time to broadcasting is expected to be much shorter in this process than in the conventional news gathering process. Furthermore, it is possible, by using the present system and method, to eliminate the significant cost that is expended for establishing and maintaining the contribution circuit (i.e., point-to-point circuit) and its peripherals that are conventionally employed for TV broadcasting. The present system and method are provided to control the flow of a news material and associated information, and are configured based on the notion of C-to-B (consumer to business) to reestablish the value of news materials and return the broadcasting task under the professionals' control.

Typically, a bystander who happens to be present at an event site, for example, an accident site where a person is being run over by a train, captures the shocking scene and releases the video to the public without concealing his/her identity. More often than not, the bystander gets accused for not saving the person but instead spending time to capture the scene. However, the present system and method allow bystanders to remain anonymous, since the information pertaining to the bystander, including his/her ID, account information, etc., can be secured in the server 204 and remain unreleased to the business entities, public domains, general audience and others. This anonymity rids bystanders of hesitation in capturing shocking images and/or sounds, thereby promoting active news gathering by bystanders.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A system for providing business entities with news materials obtained by bystanders, the system comprising:
a plurality of devices associated with a plurality of bystanders, respectively, wherein each device is capable of capturing images, sounds or both of an event as a news material, the event being encountered by the bystander associated with the device;
a plurality of client terminals associated with a plurality of business entities, respectively, wherein each client terminal is capable of receiving the news material; and
a server coupled to the plurality of devices and to the plurality of client terminals,
wherein
the device is controlled to submit the news material to the server; and
the server is configured to receive the news material and send the news material to one or more client terminals that are associated, respectively, with one or more business entities who want to obtain the news material, and to manage transactions associated with the news material.

2. The system of claim 1, wherein
each device is coupled to a first application for performing operations for the bystander;
each client terminal is coupled to a second application for performing operations for the business entity; and
the server, the first application and the second application are configured to manage an auction of the news material,
wherein
the device is controlled by the first application to submit the news material to the server;
the client terminal is controlled by the second application to submit a bidding price for the news material to the server; and
the server is configured to receive one or more bidding prices submitted by one or more client terminals associated respectively with one or more business entities who want to purchase the news material, determine a winning bidder who is the business entity associated with the client terminal that submitted the highest bidding price within a predetermined time period, and send the news material to the client terminal associated with the winning bidder, and to manage the transactions associated with the auction of the news material.

3. The system of claim 2, wherein
the device is further controlled by the first application to show legal matters including an inquiry as to whether the bystander agrees to transfer entire ownership of the news material exclusively to a party who purchases the news material.

4. The system of claim 3, wherein
the patty is the winning bidder.

5. The system of claim 3, wherein
the party is an intermediary buyer represented by the server who purchases the news material from the bystander before the auction.

6. The system of claim 1, wherein
each device is coupled to a first application for performing operations for the bystander;
each client terminal is coupled to a second application for performing operations for the business entity; and
the server, the first application and the second application are configured to manage licensing of the news material,
wherein
the device is controlled by the first application to submit to the server the news material;
the client terminal is controlled by the second application to submit to the server an acceptance notice from the business entity who wants to license-in the news material; and
the server is configured to receive one or more acceptance notices submitted by one or more client terminals associated respectively with one or more business entities who want to license-in the news material, and send the news material to the one or more client terminals associated respectively with the one or more business entities who want to license-in the news material, and to manage the transactions associated with the licensing of the news material.

7. The system of claim 6, wherein
the device is further controlled by the first application to show legal matters including an inquiry as to whether the bystander agrees to license part of rights associated with the news material non-exclusively to the one or more business entities who want to license-in the news material, and to submit an asking price that is an asking amount of a license fee.

8. The system of claim 6, wherein
the server is further configured to purchase the news material as an intermediary buyer before the licensing and to determine an asking price that is an asking amount of a license fee.

9. The system of claim 1, wherein
the device includes one or more cameras to capture the images of the event, one or more microphones to capture the sounds of the event, or a combination of both.

10. The system of claim 1, wherein
the plurality of business entities include two or more of TV broadcasting companies, magazine companies, radio stations, newspaper companies, tabloid companies and other news providers.

11. The system of claim 1, wherein
the server comprises:
an image and sound processing module to process the news material to create a first version and a second version of the news material; and
a memory to store the first version and the second version of the news material.

12. The system of claim 11, wherein
the server is further configured to send the first version to one or more client terminals for the respective business entities to review the news material.

13. The system of claim 1, wherein
the server is further configured to send a notice to one or more client terminals, the notice indicating that the news material is submitted and inviting one or more business entities associated respectively with the one or more client terminals to obtain the news material.

14. The system of claim 1, wherein
the device is controlled by the first application to submit to the server first information pertaining to the bystander associated with the device;
the client terminal is controlled by the second application to submit to the server second information pertaining to the business entity associated with the client terminal; and
the server is configured to manage the transactions using the first information and the second information.

15. A method for providing business entities with news materials obtained by bystanders, the method comprising:
first receiving a news material from a device associated with a bystander, wherein the device is capable of capturing images, sounds or both of an event as the news material, the event being encountered by the bystander associated with the device;
sending the news material to one or more client terminals that are associated, respectively, with one or more business entities who want to obtain the news material; and
managing transactions associated with the news material.

16. The method of claim 15, wherein
the method is based on auction and further comprises:
second receiving one or more bidding prices for the news material from one or more client terminals associated respectively with one or more business entities who want to purchase the news material; and
determining a winning bidder who is the business entity associated with the client terminal that submitted the highest bidding price within a predetermined time period,
wherein
the sending the news material comprises sending the news material to the client terminal associated with the winning bidder, and
the managing transactions comprises managing transactions associated with the auction of the news material.

17. The method of claim 16, further comprising:
showing legal matters including an inquiry as to whether the bystander agrees to transfer entire ownership of the news material exclusively to the winning bidder.

18. The method of claim 16, further comprising:
purchasing the news material as an intermediary buyer before the auction.

19. The method of claim 15, wherein
the method is based on licensing and further comprises:
second receiving one or more acceptance notices from one or more client terminals associated respectively with one or more business entities who want to license-in the news material,
wherein
the sending the news material comprises sending the news material to the one or more client terminals associated respectively with the one or more business entities who want to license-in the news material, and
the managing transactions comprises managing transactions associated with the licensing of the news material.

20. The method of claim 19, further comprising:
showing legal matters including an inquiry as to whether the bystander agrees to transfer part of rights associated with the news material non-exclusively to the one or more business entities who want to license-in the news material, wherein an asking price that is an asking amount of a license fee is submitted by the bystander.

21. The method of claim 19, further comprising:
purchasing the news material as an intermediary buyer before the licensing; and
determining an asking price that is an asking amount of a license fee.

22. The method of claim 15, further comprising:
processing the news material to create a first version and a second version of the news material; and
storing the first version and the second version of the news material.

23. The method of claim 22, further comprising:
sending the first version to one or more client terminals for respective business entities to review the news material.

24. The method of claim 15, further comprising:
sending a notice to one or more client terminals associated respectively with one or more business entities, the notice indicating that the news material is submitted and inviting the one or more business entities to obtain the news material.

25. The method of claim 15, further comprising:
controlling the device to submit first information pertaining to the bystander associated with the device; and
controlling each of the one or more client terminals to submit second information pertaining to the business entity associated with the client terminal,
wherein
the managing transactions comprises managing transaction using the first information and the second information.
